(19) United States
(12) Patent Application Publication
(10) Pub. No.: US 2024/0010469 A1
(43) Pub. Date: Jan. 11, 2024

(54) Piling Head Threaded Puller Device

(71) Applicant: L & C Fabrication LLC, Des Allemands, LA (US)

(72) Inventor: Leonard J. Dufrene, Des Allemands, LA (US)

(73) Assignee: L & C Fabrication LLC, Des Allemands, LA (US)

(21) Appl. No.: 18/371,655

(22) Filed: Sep. 22, 2023

(51) Int. Cl. B66C 1/10

(52) U.S. Cl. CPC B66C 1/10

(57) ABSTRACT

A piling head puller device comprises an elongated cylindrical rod having drive head at a proximal end thereof, an upper section having smooth outer surface portion between the drive head and a stop flange, and a lower section having a threaded outer surface portion rom the stop flange to the distal end. The piling head puller device includes a swiveling lifting element having a pull ring and a bearing washer, which defines a glide hole through which the elongated cylindrical rod extends and moves axially freely between the drive head and the stop flange, such that the pull ring is positionable at an angle to avoid obstruction with the elongated cylindrical rod. Rotation of the drive head removably embeds the threaded outer surface portion into a wooden piling head. A hoist can pull the lifting element which bears on the drive head to remove the wooden piling from the ground.

### BACKGROUND OF THE INVENTION

### Field of the Invention

The present invention relates generally to electric pole removing devices and more particularly to piling head pulling devices.

### Description of the Related Art

Use of poles is common in electrical infrastructure. Electrical poles, often times also known as utility poles, are usually made of wood, metal, or concrete and are used for supporting power lines, communication cables, and other equipment necessary for electrical distribution. Timber piles or pilings are made from timber obtained from a tree. A wooden piling is often used for foundations and structural support as an electrical pole. However, over time, these poles can become damaged due to natural wear and tear, harsh weather conditions, or accidents. When this happens, it becomes necessary to replace or repair the damaged poles.

Conventionally, when an electrical pole such as a wooden piling is broken or damaged, one conventional method for removal of the pole (including the piling) is to use a chain to lift the piling. Specifically, an operator wraps a chain around the top of the pole, also known as the head or cap, and cinch it tight. The chain is then lifted by a crane to remove the pole from its foundation.

However, there are drawbacks to using chains to remove damaged electrical poles. For one, there is a risk of the chain slipping off the head of the piling during the lifting process, which could cause the pole to fall and potentially injure workers or damage property. Additionally, the process can be inefficient, as it may require multiple attempts to lift the pole out of the ground and place it in the desired location.

Over the years, various devices have been made to assist operators with removal of wooden piling electrical poles. Devices including hydraulic pole pullers and pneumatic pole extractors have been used; however, they are complex to use, unsafe, and inefficient. Such devices require manual operation and considerable effort by operators in attaching to piling heads to pull and remove such electrical poles. Further, in many cases, due to limited accessibility in many locations, such conventional devices cannot be used.

People have long used conventional devices such as chains or wires hooped around piling heads to remove such pilings from the ground, but such devices do not provide adequate stability, safety, and support. There is a fear of slippage of such conventional devices during lifting or pulling operations which can lead to serious injuries. Further, conventional piling removing devices do not allow operators to use automated tools such as a combination of a drill and a crane for removing wooden piling electrical poles.

None of the existing piling removal devices include a convenient, effective, and efficient way to remove wooden piling electrical poles easily, safely, and effectively.

A need exists for new devices that provide a more stable, secure, and safe way for operators to connect their pulling devices to piling heads without fear of slippage and danger.

While conventional devices may be partly suitable for the particular purposes employed, they would not be as suitable for the purposes of the present invention as disclosed hereafter. None of such conventional devices disclose the unique structures and advantages of the present disclosure. The devices disclosed herein avoid many of the drawbacks of existing devices.

Accordingly, there is a need for an improved piling head puller device that significantly eases the process of removing electrical poles without using conventional chains, ropes and other similar items. Conventional chains, ropes and other similar items wrapped around a piling head have a tendency to slip off of the piling head, or break off an upper portion of the piling head, during a pulling or lifting operation, which poses great risk of harm to operators.

It is one prospect of the present invention to provide a novel piling head puller device of simple but effective construction for convenient and efficient pulling of piling heads without risk of injury to an operator and without damage to the piling head.

Another object of the present invention is to provide a piling head puller device that can be attached to a head of a piling using a conventional drill for safe and easy pulling and removal of the piling from the ground.

Yet another object of the disclosed invention is to provide a piling head puller device that includes a moveable lifting element for connecting to a hook of a hoist to pull and remove a piling from the ground easily and safely.

Yet another object of the disclosed invention is to provide a piling head pulling device that eliminates most of the manual effort of operators when attaching to a piling head and removing such piling form the ground.

Yet another object of the disclosed invention is to provide a piling head pulling device that does not break or damage a piling head when pulled, for effective piling removal operations.

Yet another object of the disclosed invention is to provide a piling head pulling device that has a threaded elongated portion which is installed inside a piling head enabling an operator to lift the piling head by connecting a hook of a hoist to the moveable lifting element.

As disclosed in this application, the inventor has discovered novel and unique devices for efficiently and effectively removing a piling without damaging the piling head and while avoiding injury to operators, while saving tremendous effort during the piling removal process.

Embodiments of the present invention provide for a piling head puller device as described and defined in the description below and in the annexed claims which provide for improved safety, efficiency and effectiveness characteristics in order to conveniently and more effectively connect to piling heads to uplift pilings in a multitude of environments.

### SUMMARY OF THE INVENTION

The following presents a simplified summary of the present disclosure in a simplified form as a prelude to the more detailed description that is presented herein.

Therefore, in accordance with embodiments of the invention, there is provided a piling head puller device comprising an elongated cylindrical rod having a proximal end and an opposite distal end. The proximal end includes a drive head preferably having a hexagonally shaped drive nut that is integrally molded therewith. The drive nut is preferably adapted to fit into a drill head. A portable cordless drill, a corded drill, an impact drill, a hammer drill and the like can provide the drill head.

In one embodiment, the piling head puller device has a driving position, for installing the outer threaded portion of the elongated cylindrical rod into a wooden piling head, and the wooden piling head puller device has a pulling position, for pulling and uplifting the piling head in order to remove the wooden piling from the ground.

In a preferred embodiment, the elongated cylindrical rod has a smooth cylindrical outer surface portion disposed between the drive head and a stop flange. The cylindrical rod has a threaded outer surface portion disposed between the stop flange and the distal end of the elongated cylindrical rod.

The threaded outer surface portion of the elongated cylindrical rod includes a plurality of continuous threads that are adapted to be driven axially into a top of a piling head, to mount the piling head puller device to the piling head in a pulling position, when the drive nut is rotated by the drill head.

The piling head puller device comprises a lifting element that is configured for axial movement along the smooth cylindrical outer surface portion of the elongated cylindrical rod. The lifting element includes a bearing washer, that has a glide hole, and a pull ring fixed to the bearing washer, where the pull ring extends from the bearing washer on a perpendicular plane relative to a horizontal plane of the bearing washer. The pull ring is adapted to provide a secure and stable connection to a hook of a hoist to pull the piling head while the threaded outer surface portion is embedded in the wood piling.

In a preferred embodiment, the top surface of the bearing washer abuts a bottom surface of the drive nut, and the pull ring extends axially above the drive head nut when the pull ring is attached to the hook and is pulled by the hoist for pulling the piling device and the piling head vertically upward, while the threaded outer surface portion is stuck in the piling head.

In a preferred embodiment, the threaded outer surface portion is embedded in the piling head in a driving position, wherein the pull ring is positioned at an angle that departs from a vertical axis of the elongated cylindrical rod preventing the pull ring from colliding with or obstructing with the elongated cylindrical rod, when the drill head rotates the drive nut in the driving position.

Preferably, the pull ring has a first edge, a second edge and an arcuate top edge. The first edge has an elongated member, a notch and a bottom transversal portion, wherein the notch accommodates a circumferential point of the bearing washer.

Preferably, the second edge has an elongated member, notch, and a bottom transversal portion, wherein the notch accommodates a circumferential point of the bearing washer.

Preferably, the hook engages with the arcuate top edge for lifting the piling head puller device and the piling head.

In a preferred embodiment, the length of the threaded outer surface portion is at least sixteen inches and is about at least 1.5 times of the length of the smooth cylindrical outer surface portion.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which:

FIG. 1 illustrates a perspective view of the piling head puller device, in accordance with embodiments of the invention;

FIG. 2 illustrates the piling head puller device of FIG. 1 in a pulling position, showing the moveable lifting element touching the drive head nut, in accordance with embodiments of the invention;

FIG. 3 illustrates the piling head puller device of FIG. 1 in a driving position, in accordance with embodiments of the invention;

FIG. 4 illustrates a close view of the glide hole of the bearing washer of the lifting element enabling axial and swiveling movement along the smooth cylindrical outer surface portion, in accordance with embodiments of the invention;

FIG. 5 illustrates a perspective view of the moveable lifting element of the piling head puller device of FIG. 1, showing the pull ring and the bearing washer, in accordance with embodiments of the invention;

FIG. 6 is an exploded view of the piling head puller device of FIG. 1, in accordance with embodiments of the invention;

FIG. 7 illustrates an exemplary piling head puller device in the driving position with a drill attached to the drive nut and illustrating the threaded outer surface portion installed and embedded in a piling head, in accordance with embodiments of the invention;

FIG. 8 illustrates an exemplary piling head puller device in the pulling position with a hook of a hoist attached to the pull ring, in accordance with embodiments of the invention;

FIG. 9 illustrates an exemplary piling head being removed from the ground, in accordance with embodiments of the invention;

FIG. 10 illustrates a cross-sectional view of the engagement of the piling head puller device in a pulling position with the moveable lifting element engaging the drive head nut, in accordance with embodiments of the invention; and

FIG. 11 illustrates a flow diagram depicting an process of using the piling head puller device of the present invention, in accordance with embodiments of the invention.

### DETAILED DESCRIPTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

Reference will now be made in detail to the present preferred embodiments of the invention, examples of which are illustrated in the accompanying drawings. Wherever possible, the same reference numerals are used in the drawings and the description to refer to the same or like parts.

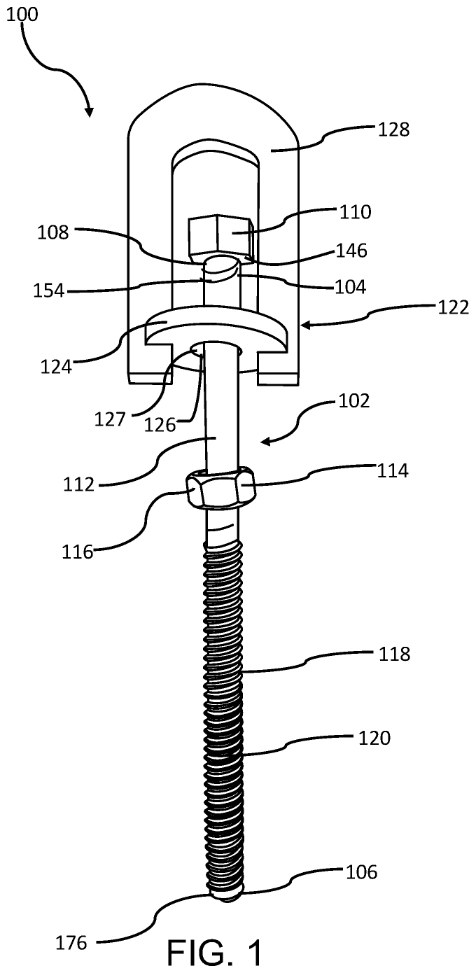

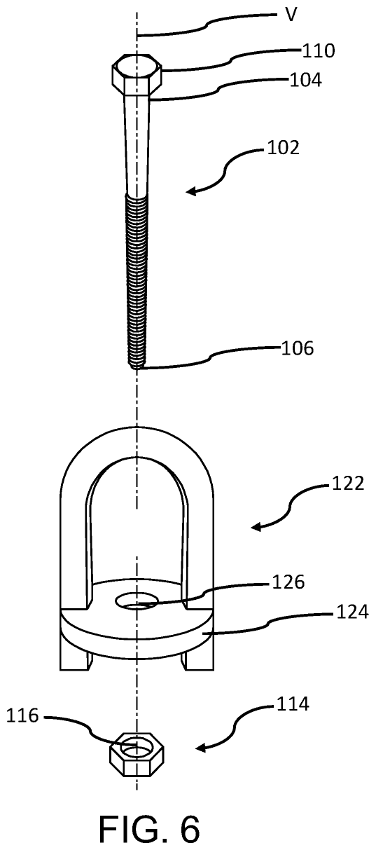

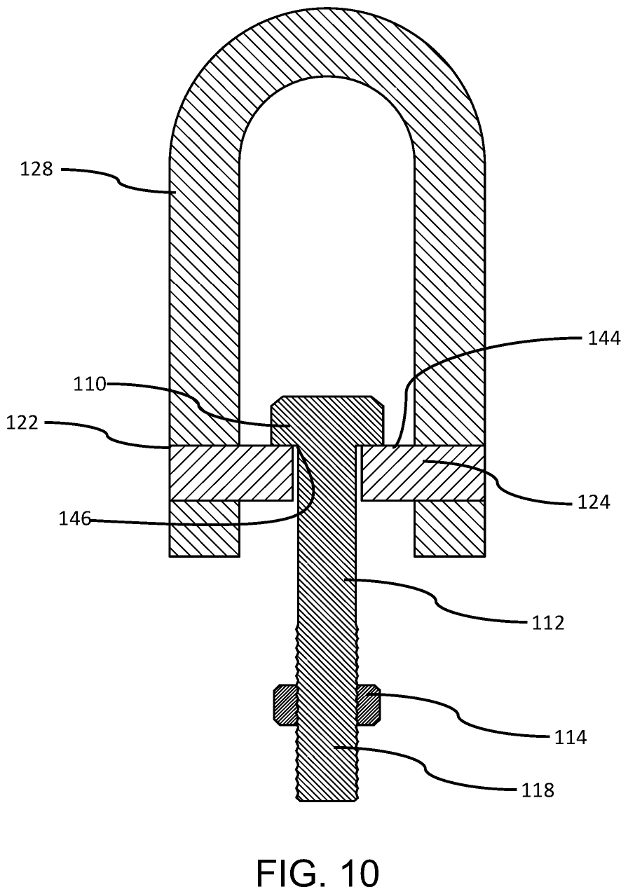

Referring initially to FIGS. 1-6 and 10, the basic constructional details and principles of operation of embodiments of a piling head puller device 100 are provided.

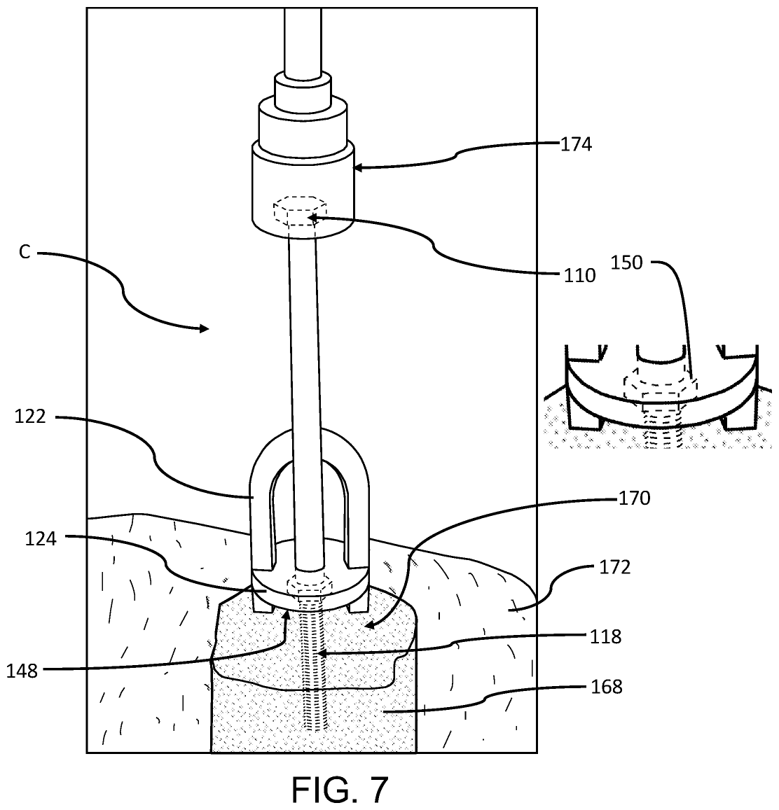

As illustrated in FIG. 1, in a preferred embodiment, the piling head puller device 100 includes an elongated and solid cylindrical rod 102 having a proximal end 104 and an opposite distal end 106. The proximal end 104 has a drive head 108 adapted to fit in a drill head 174. In a preferred embodiment, the drive head 108 is forged or integrally formed as a hexagonally shaped drive nut 110. The hexagonally shaped drive nut 110 is integrally molded with the elongated cylindrical rod 102, at the proximal end thereof, and the hexagonally shaped drive nut 110 is adapted to fit in a socket of the drill head 174, as illustrated in FIG. 7. The hexagonally shaped drive nut 110 can be rotated by the drill head 174 to rotate the elongated cylindrical rod 102 of the piling head puller device 100 during driving operation, as illustrated in FIG. 7. The elongated cylindrical rod 102 has a smooth cylindrical outer surface portion 112 disposed between the drive head 108 and a stop flange 114. In one embodiment, the stop flange 114 is in the form of a hexagonal nut 116 that is welded to the elongated cylindrical rod 102. In a preferred embodiment, the stop flange 114 is integrally forged or molded with the elongated cylindrical rod 102 as a unitary construction.

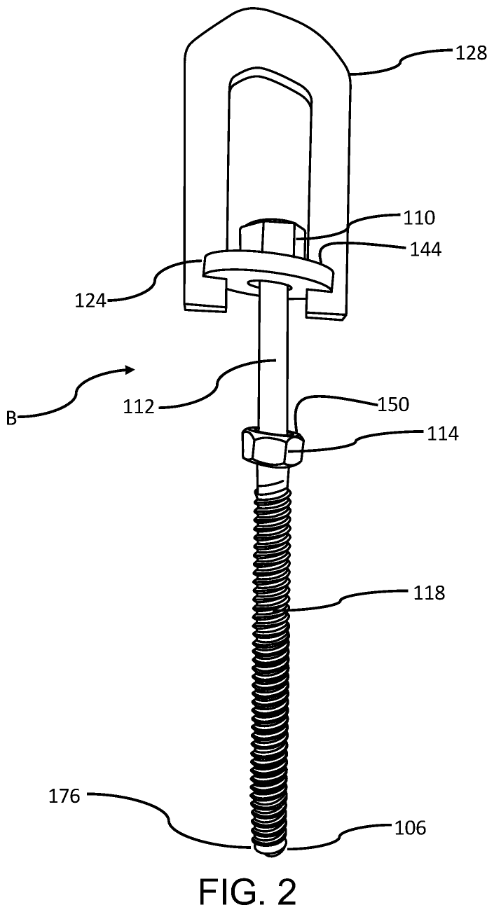

Referring to FIGS. 1 and 2, the cylindrical rod 102 has a threaded outer surface portion 118 disposed between the stop flange 114 and the distal end 106 of the cylindrical rod 102. In a preferred embodiment, the length of the threaded outer surface portion 118 is at least sixteen inches and is preferably at least 1.5 times of the length of the smooth cylindrical outer surface portion 112. It is contemplated that any other relative lengths of the smooth cylindrical outer surface portion 112 and the threaded outer surface portion 118 can be used in the device 100 based on the manufacturing requirements of the piling head puller device 100 and preferences of the users. The threaded outer surface portion 118 has a plurality of continuous threads 120. The thread pitch and thread angle of the plurality of continuous threads 120 of the threaded outer surface portion 118 of the elongated cylindrical rod 102 can vary depending on the length and width of the threaded outer surface portion 118.

Preferably, the distal end 106 of the elongated cylindrical rod 102 preferably includes a two-step thread 176 (also known as a two start or double thread) for effective insertion of the threaded outer surface portion 118 in a top surface 170 of a wooden piling head 168. In a preferred embodiment, the plurality of continuous threads 120 are double lead threads (i.e., a two start or double thread). A double lead screw thread has a lead (L) that is equal to twice the pitch.

In other embodiments, the plurality of continuous threads 120 are multiple start threads. Each multiple start thread lead is equal to an integral multiple of two or more times the pitch of the thread.

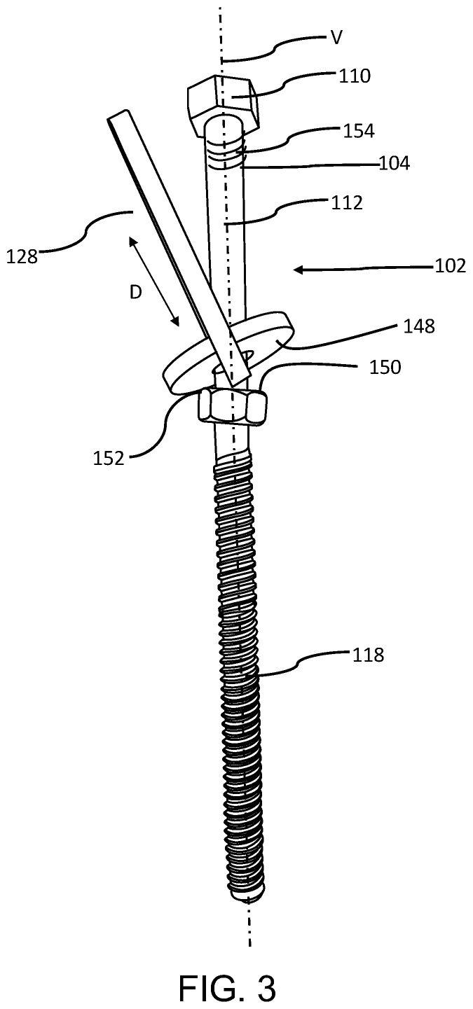

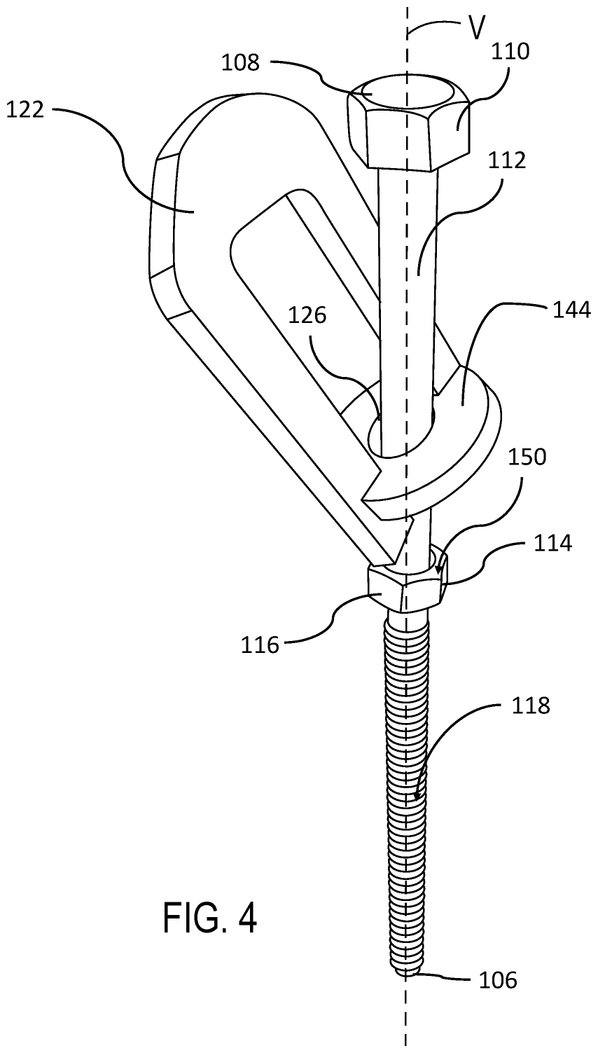

Additionally, as shown in FIGS. 3-4 and 7, the threaded outer surface portion 118 of the elongated cylindrical rod 102 is adapted to be driven axially into a top 170 of a piling head 168 and embed into the wood piling 168 when the drive nut 110 is rotated by the drill head 174, as shown in FIG. 7. To facilitate a user's driving of the drive nut 110 with a drill head 174 in order to rotate the elongated cylindrical rod 102 to drive the threaded outer surface portion 112 into the piling head 168, the lifting element 122 can swivel relative to the elongated cylindrical rod 102 and can also tilt to an angle (as shown in FIGS. 3-4) that departs from a vertical axis V of the elongated cylindrical rod; and the glide hole 126 also allows the lifting element 122 to slide axially along the smooth outer surface portion 112 of the elongated cylindrical rod 102, where the lifting element 122 can rest against a portion 152 of the stop flange 114. The glide hole 126 allows the smooth movement of the lifting element 122 along the smooth outer surface portion 112 of the elongated cylindrical rod 102 to meet the stop flange 114. In such manner, the swiveling, tilting, and axial positioning of the lifting element 122 enable an operator to have unobstructed access to the drive nut 110 when the operator drills the elongated cylindrical rod 102 into the head of the piling 168, as exemplified in FIGS. 3-4 and 7.

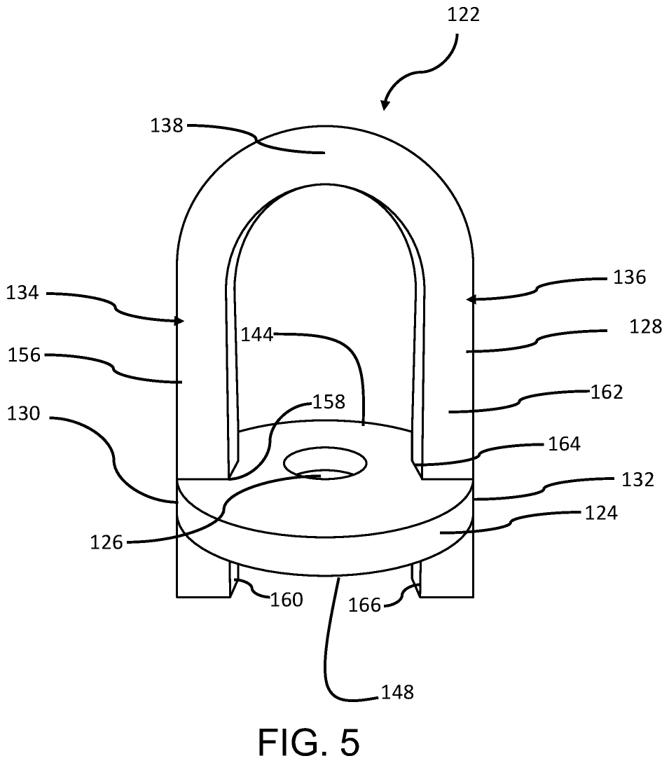

Referring to FIGS. 1-6, the piling device 100 has a lifting element 122 configured for axial movement along the smooth cylindrical outer surface portion 112. Specially referring to FIG. 5, the lifting element 122 includes a generally circular bearing washer 124 which defines a glide hole 126 disposed within the center of the bearing washer 124. Preferably, the glide hole 126 is substantially round or circular in shape, as illustrated in FIG. 5. The smooth cylindrical outer surface portion 112 of the elongated cylindrical rod 102 extends through the glide hole 126, such that the lifting element 122 is freely moveable axially between the drive head 108 and the stop flange 114. The lifting element 122 is also able to swivel around the elongated cylindrical rod 102 between the drive head 108 and the stop flange 114. As such, the glide hole 126 movably engages the smooth cylindrical outer surface portion 112 of the cylindrical rod 102. In other words, the glide hole 126 allows the lifting element 122 to tilt on an angle and to move axially between the drive head nut 110 (as illustrated in FIG. 2) and the stop flange 114 (as illustrated in FIG. 3) when using and operating the piling head puller device 100.

The lifting element 122 has an integrally molded pull ring 128 extending from the bearing washer 124 preferably on a perpendicular plane relative to the bearing washer 124. The pull ring 128 is preferably of an inverted U-shape and extends across two opposite points 130, 132 of the bearing washer 124.

Referring again to FIG. 5, in one embodiment, the pull ring 128 of the lifting element 122 has a pair of edges 134, 136, with a first edge 134 extending from the circumferential point 130 and a second edge 136 extending from the opposite circumferential point 132. An arcuate top edge 138 connects the edges 134, 136 and is used for pulling the piling puller device 100. The first edge 134 has an elongated member 156 having a notch 158 for accommodating the circumferential point 130 and has a bottom transversal portion 160 touching the bottom surface 148 of the bearing washer 124. Similarly, the second edge 136 has an elongated member 162 having a notch 164 for accommodating the opposite circumferential point 132. The second edge 136 has a bottom transversal portion 166 touching the bottom surface 148 of the bearing washer 124.

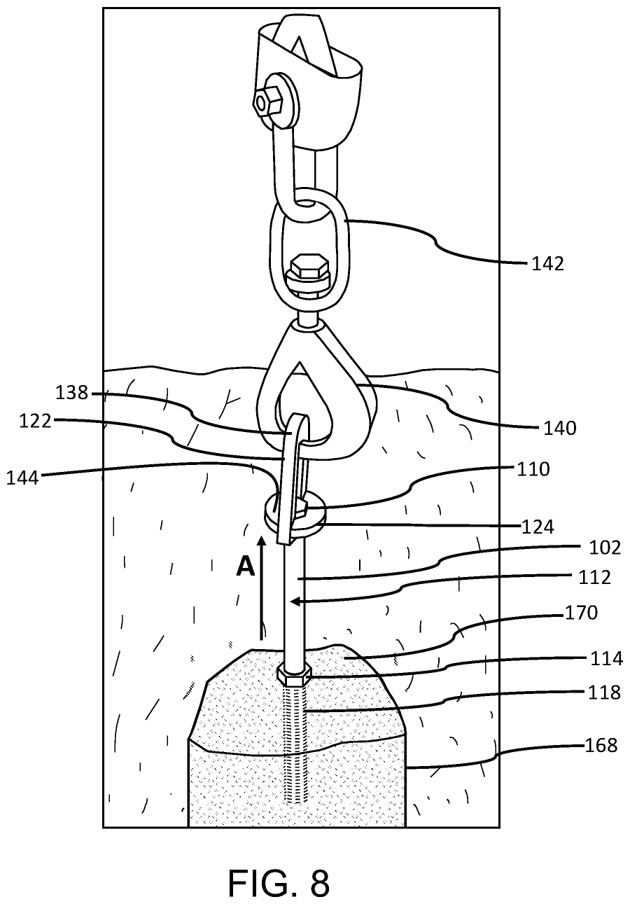

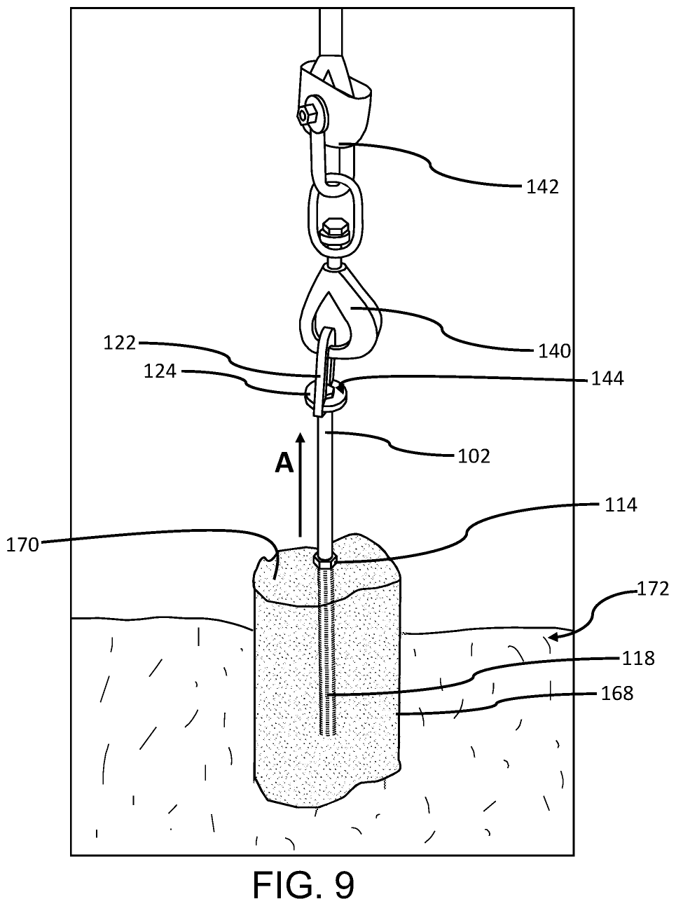

Referring to FIGS. 8-9, the pull ring 128 of the lifting element 122 is adapted to receive a secure and stable connection to a hook 140 of a hoist 142, enabling the hoist 142 to pull the piling head puller device 100 and removably connected piling head 168 out of the ground 172, in the direction of Arrow A as illustrated in FIGS. 8-9. As shown, the lifting element 122 can be lifted (axially along axis V) in an upward direction (Arrow A, FIG. 8), and the bearing washer 124 of the lifting element 122 bears upwardly (meaning, it imparts an upward force) against the drive head 108, which exerts an upward force on the elongated cylindrical rod 102 thereby pulling upwardly the wooden piling 168 to which it is removably connected, when the threaded outer surface portion 118 of the elongated cylindrical rod 102 is embedded in the wooden piling head 168, as illustrated in FIGS. 8-9.

Referring back to FIGS. 1 and 3, in one embodiment, the proximal end 104 of the cylindrical rod 102 has a threaded portion 154, and the glide hole 126 has an inner (female) threaded portion 127 that allows the glide hole 126 to threadedly engage and maintain a threaded engagement with the threaded portion 154 of the proximal end 104 of the cylindrical rod 102. In such embodiment, his prevents the lifting element 122 from automatically moving along the smooth cylindrical outer surface portion 112 of the cylindrical rod 102 when such as done on application of the drill head 174 on the drive nut 110).

Referring again to FIGS. 1-2 and 8-10, the top surface 144 of the bearing washer 124 abuts and bears upwardly upon a bottom surface 146 of the drive nut 110 when the lifting element 122 is attached to the hook 140 of a hoist 142 and is pulled upwardly by the hoist 142 when the piling head puller device 100 is in a pulling position, illustrated at Arrow B in FIG. 2. In operation, the piling head puller device 100 can be pulled upwardly by the hoist 142 when the threaded outer surface portion 118 is embedded within a piling head 168, as illustrated in FIGS. 8-9, such that an upward lifting by the hoist 142 lifts up the lifting element 122, which engages and lifts up the drive head 108, which pulls up the wooden piling 168 within which the distal end 106 of the elongated cylindrical rod 102 is embedded.

In the pulling position, the pull ring 128 extends axially above the drive head nut 110, thereby, the drive head nut 110 does not obstruct the hook 140 while pulling the device 100. During pulling, the piling head 168 in which the threaded outer surface portion 118 is stuck, is pulled from the ground 172 without damaging the piling head 168.

Referring to FIGS. 3-4 and 6-7, the piling device 100 is in a driving position (Arrow C; FIG. 7). In the driving position C, the threaded outer surface portion 118 of the piling device 100 is installed in the wooden piling 168, by a rotation of the drive nut 110 by a socket of the drill head 174 drilling and driving the threaded outer surface portion 118 of the elongated cylindrical rod 102 through the top surface 170 and embedding into the wooden piling 168.

As illustrated in FIG. 7, since the bottom surface 148 of the bearing washer 124 of the lifting element 122 can abut at least a portion 152 of a top surface 150 of the stop flange 114 while the piling head puller device 100 is in the driving position C, then the lifting element 122 does not obstruct access to the drive head 108. In other words, as shown in FIGS. 3-4, the pull ring 128 is positioned at an angle (shown through Arrow D; FIG. 3) that departs from the vertical axis V (FIGS. 3-4 and 6) of the elongated cylindrical rod 102 so that the pull ring 128 does not collide with or obstruct the elongated cylindrical rod 102. During an installation of the threaded outer surface portion 118 of the elongated cylindrical rod 102 into the piling head 168, the lifting element 122 can also be moved axially (lower) toward the threaded outer surface portion 118 of the elongated cylindrical rod 102 to provide ease of unobstructed access to the drive head 108 of the elongated cylindrical rod 102 while the user drills (rotates) the drive head 108 in a clockwise manner to drive the outer threaded surface portion 118 of the elongated cylindrical rod 102 into the wooden piling head 168.

As can be appreciated from the disclosure herein, the piling head puller device 100 is positionable between a driving position C, as illustrated in FIGS. 3-4 and 7, and a pulling position B as illustrated in FIGS. 2 and 8-9). In the driving position C, the pull ring 128 of the lifting element 122 is positioned at an angle D (FIG. 3) that departs from the vertical axis V of the elongated cylindrical rod 102, such that a rotation of the hexagonally shaped drive nut 110 in a clockwise direction is configured to embed the threaded outer surface 118 of the elongated cylindrical rod 102 into the wooden piling 168.

In the pulling position B, referring to FIGS. 2 and 8-9, the pull ring 128 of the lifting element 122 is positioned at an angle that is in alignment with the vertical axis V of the elongated cylindrical rod 102, such that an uplifting force Arrow A (FIG. 9) of a hoist 142 that is removably connected to the pull ring 128 imparts an upward lifting force Arrow A on the bearing washer 124 that upwardly bears on the hexagonally shaped drive nut 110, which imparts an uplifting force Arrow A on the elongated cylindrical rod 102. Such uplifting force Arrow A on the elongated cylindrical rod 102 imparts a resulting uplifting force Arrow A on the wooden piling 168 within which the threaded outer surface portion 112 of the elongated cylindrical rod 102 is embedded.

The elongated cylindrical rod 102 of the piling head puller device 100 can be easily removed from the wooden piling head 168 in a manner similar to installation but with an opposite rotation of the elongated cylindrical rod 102. Meaning, a user can rotate the drive head 108 of the elongated cylindrical rod 102 in a counter-clockwise manner in order to back out or withdraw the threaded outer surface portion 118 of the elongated cylindrical rod 102 from the wooden piling head 168. Accordingly, through embodiment disclosed herein, the elongated cylindrical rod 102 of the piling head puller device 100 is removably connected to the wooden piling head 168, in a safe and efficient manner, at the option of the user.

In a preferred embodiment, the elongated cylindrical rod 102 and the lifting element 122 are each forged from carbon steel. The elongated cylindrical rod 102, in different embodiments, can be made from one of materials having high resistance to wear and tear such as steel, stainless steel, or aluminum. Preferably, the stop flange 114 is forged along with the elongated cylindrical rod 102 as a unitary construction (i.e., as one piece). In another embodiment, the stop flange 114 is welded onto the elongated cylindrical rod 102.

In another embodiment, the stop flange 114 can be made of a similar material as the cylindrical rod 102 or can be made of a different material, such as a polymer or a reinforced plastic, to reduce weight and increase ease of handling. The lifting element 122 can be made of a lighter and durable material, such as aluminum, steel, or an alloy, as the lifting element 122 is required to move axially along the smooth cylindrical outer surface portion 112. Embodiments of the present invention are intended to include or otherwise cover any type of the material for the piling device 100 and any of its components including known, related art, and/or later developed technologies. When use of piling head puller device 100 is no longer desired, the device 100 can be easily stored in the backseat of a vehicle or a truck for easy storage and transportability.

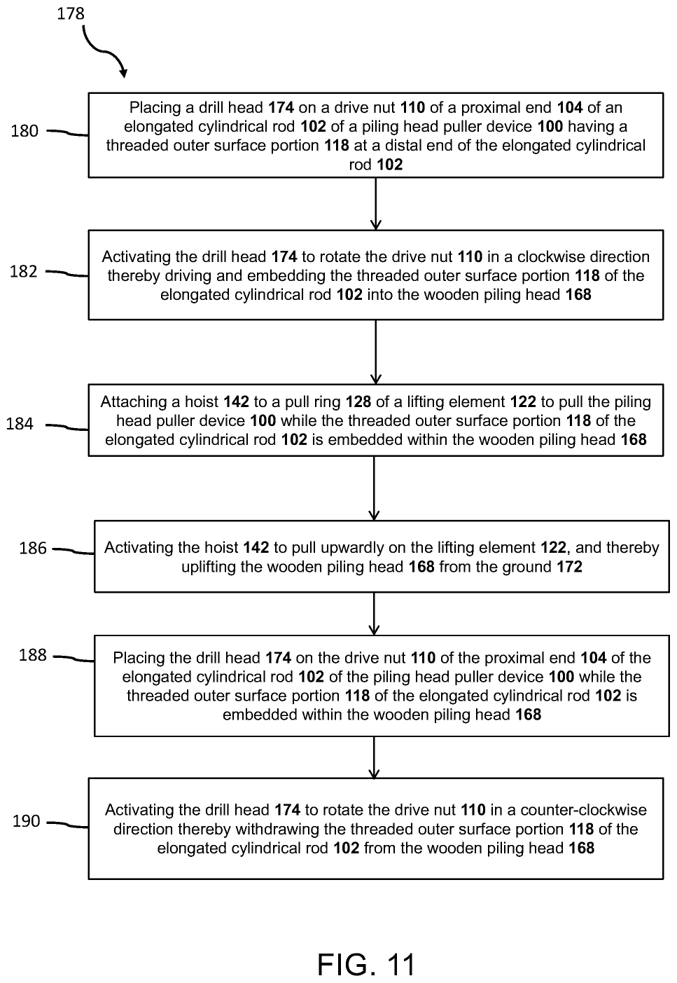

Referring to FIG. 11, in accordance with embodiments of the invention, there is provided a method 178 for uplifting a wooden piling 168 from a ground 172, using a piling head puller device 100. In one embodiment, the method includes a first step 180 of placing a socket of a drill head 174 onto the drive nut 110 of the piling head puller device 100 while the distal end 106 of the elongated cylindrical rod 102 is positioned on top of a piling head 168. The method includes a second step 182 of activating the drill head 174 to rotate the drive nut 110 in a clockwise direction thereby driving and embedding the threaded outer surface portion 118 of the elongated cylindrical rod 102 into the wooden piling head 168, as illustrated in FIG. 7. The method includes a third step 184 of attaching a hoist 142 to a pull ring 128 of a lifting element 122 to pull upwardly on the piling head puller device 100 while the threaded outer surface portion 118 of the elongated cylindrical rod 102 is embedded within the wooden piling head 168. The method includes a fourth step 186 of activating the hoist 142 to pull upwardly on the lifting element 122 and thereby uplifting the wooden piling 168 from the ground 172. In such manner, the wooden piling 168 is unrooted from the ground 172 in a safe an efficient manner. In another embodiment, the method includes a fifth step 188 of placing the socket of a drill head 174 onto the drive nut 110 of the piling head puller device 100 while the threaded outer surface portion 118 of the elongated cylindrical rod 102 is embedded within the wooden piling head 168. In such embodiment, the method includes a sixth step 190 of activating the drill head 174 to rotate the drive nut 110 in a counter-clockwise direction thereby withdrawing the threaded outer surface portion 118 of the elongated cylindrical rod 102 from the wooden piling head 168.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation within the spirit and scope of the appended claims.

The claimed invention is:

1. A piling head puller device comprising:
an elongated cylindrical rod having a proximal end and an opposite distal end, said proximal end including a drive head adapted for engagement with a drill head, the elongated cylindrical rod having a smooth cylindrical outer surface portion disposed between the drive head and a stop flange, the elongated cylindrical rod having a threaded outer surface portion disposed between the stop flange and the distal end of the elongated cylindrical rod, the threaded outer surface portion comprising a plurality of continuous threads;
a lifting element comprising a pull ring and a bearing washer, the pull ring adapted for removable connection to a hoist, the bearing washer defining a glide hole through which the elongated cylindrical rod axially extends between the drive head and the stop flange.

2. The piling head puller device of claim 1, wherein the drive head comprises a hexagonally shaped drive nut adapted for engagement with a socket of the drill head.

3. The piling head puller device of claim 1, wherein the plurality of continuous threads on the threaded outer surface portion are double lead threads.

4. The piling head puller device of claim 1, wherein the plurality of continuous threads on the threaded outer surface portion are multiple start threads, each multiple start thread having a respective lead equal to an integral multiple of two or more times a pitch of the respective thread.

5. The piling head puller device of claim 1, wherein the lifting element is adapted to swivel around the elongated cylindrical rod, wherein the pull ring is configured for a removably secure connection to a hook of the hoist to facilitate axial movement of the lifting element along the smooth cylindrical outer surface portion in an upward direction when uplifted by the hoist, wherein said bearing washer bears upwardly upon a bottom surface of the drive head upon said uplifting of the pull ring by the hook of the hoist.

6. The piling head puller device of claim 1, wherein the pull ring is positionable at an angle that departs from a vertical axis of the elongated cylindrical rod, said angle configured to prevent the pull ring from colliding with or obstructing the elongated cylindrical rod when the drill head rotates the drive head while in a driving position.

7. A piling head puller device comprising:
an elongated cylindrical rod having a proximal end and an opposite distal end, said proximal end having a drive head comprising a hexagonally shaped drive nut integrally molded with the elongated cylindrical rod, the hexagonally shaped drive nut configured to be engaged and driven by a socket of a drill head, the elongated cylindrical rod having a smooth cylindrical outer surface portion disposed between the drive head and a stop flange that is integrally molded with the elongated cylindrical rod, the elongated cylindrical rod having a threaded outer surface portion disposed between the stop flange and the distal end of the elongated cylindrical rod, said threaded outer surface portion configured to be driven into a head of a wooden piling;
a lifting element comprising a bearing washer which defines a glide hole through which the smooth cylindrical outer surface portion of the elongated cylindrical rod extends, said lifting element comprising a pull ring extending from the bearing washer, wherein said pull ring is adapted to be removably connected to a hoist.

8. The piling head puller device of claim 7, wherein said piling head puller device is positionable between a driving position and a pulling position, wherein in said driving position, said pull ring is positioned at an angle that departs from a vertical axis of the elongated cylindrical rod such that a rotation of the hexagonally shaped drive nut is configured to embed the threaded outer surface of the elongated cylindrical rod into the wooden piling, wherein in the pulling position, the pull ring is positioned at an angle that is in alignment with the vertical axis of the elongated cylindrical rod such that an uplifting force of a hoist removably connected to said pull ring imparts an upward lifting force on the bearing washer upwardly bearing on the hexagonally shaped drive nut which imparts an uplifting force on the elongated cylindrical rod configured to uplift the wooden piling within which the threaded outer surface portion of the elongated cylindrical rod is embedded.

9. The piling head puller device of claim 7, wherein said pull ring extends perpendicularly from the bearing washer, said pull ring adapted for engagement with a hook of a hoist configured to uplift a wooden piling from the ground when the threaded outer surface portion of the elongated cylindrical rod is embedded inside said wooden piling.

10. A method for uplifting a wooden piling from a ground, comprising
a first step of placing a socket of a drill head onto a drive nut of a piling head puller device while a distal end of an elongated cylindrical rod of the piling head puller device is positioned on top of a piling head;
a second step of activating the drill head to rotate the drive nut in a clockwise direction thereby driving and embedding the threaded outer surface portion of the elongated cylindrical rod into the wooden piling head;
a third step of attaching a hoist to a pull ring of a lifting element to pull upwardly on the piling head puller device while the threaded outer surface portion of the elongated cylindrical rod is embedded within the wooden piling head;
a fourth step of activating the hoist to pull upwardly on the lifting element and thereby uplifting the wooden piling from the ground.

11. The method for uplifting a wooden piling from a ground of claim 10, comprising a fifth step of placing the socket of the drill head onto the drive nut of the piling head puller device while the threaded outer surface portion of the elongated cylindrical rod is embedded within the wooden piling head.

12. The method for uplifting a wooden piling from a ground of claim 10, comprising a sixth step of activating the drill head to rotate the drive nut in a counter-clockwise direction thereby withdrawing the threaded outer surface portion of the elongated cylindrical rod from the wooden piling head.
